(19) United States
(12) Patent Application Publication
(10) Pub. No.: US 2008/0018807 A1
(43) Pub. Date: Jan. 24, 2008

(54) Field sequential image display method and apparatus

(75) Inventors: Jun Someya, Tokyo (JP); Shuichi Kagawa, Tokyo (JP); Takahiko Yamamuro, Tokyo (JP); Hiroaki Sugiura, Tokyo (JP)

Correspondence Address: BIRCH STEWART KOLASCH & BIRCH, PO BOX 747, FALLS CHURCH, VA, 22040-0747, US

(73) Assignee: Mitsubishi Electric Corporation

(21) Appl. No.: 11/822,391

(22) Filed: Jul. 5, 2007

(30) Foreign Application Priority Data
Jul. 24, 2006 (JP) 2006-200367

(51) Int. Cl. H04N 9/12; H04N 9/31

(52) U.S. Cl. 348/742; 345/589; 348/E09.027; 348/E09.026

(57) ABSTRACT

A field sequential color display is obtained by successive display of a sequence of monochromatic images. Each monochromatic image is displayed with light occupying a different wavelength region, but one of the wavelength regions includes part or all of another one of the wavelength regions. These two wavelength regions are used to display one of the original primary colors of the color image, the included or partially included wavelength region being used for comparatively low gray levels and both wavelength regions being used for comparatively high gray levels. This scheme provides a way to increase the number of gray levels that can be displayed following a gamma correction, as well as broadening the gamut of reproducible colors.

### BACKGROUND OF THE INVENTION

1. Field of the Invention

The present invention relates to a field sequential color image display method and apparatus.

2. Description of the Related Art

The field sequential display method, which obtains a color image by using a single-element light valve to display a sequence of monochromatic images in different colors, enables the color modulator to be configured as a single compact, inexpensive device, and is widely used in projectors and projection television sets.

In a field sequential color display of the micromirror type, in which the gray scale is expressed by different reflection times of the micromirrors, Japanese Patent Application Publication No. 2000-259127 (paragraph 0024 and FIG. 1) describes technology for improving image quality by using predetermined combinations of reflection times. A problem with this scheme is that the brightness of the display varies linearly with the reflection time, so in order to implement the type of display characteristic that is generally used in display apparatus, such as the γ^{2.2} gamma characteristic, the gray scale must be converted, but the conversion process reduces the number of gray levels that are actually displayed.

Japanese Patent Application Publication No. 2004-286963 describes a technique for broadening the gamut of reproducible colors by dividing an input image expressed in the three primary colors red, green, and blue into a larger number of color fields, e.g., red-1, red-2, green-1, green-2, blue-1, blue-2, and displaying these fields sequentially. As the number of color fields increases, however, the display time for each field decreases, leading to a darkening of the pure color of each field. In addition, when a white light source and a color filter wheel are used to produce the different colors, the display is further darkened by the increased number of dark intervals by which the different monochromatic images must be separated to avoid mixing colors.

### SUMMARY OF THE INVENTION

An object of the present invention is to provide a field sequential color display method and apparatus that, without loss of brightness, can reproduce more gray levels and a wider gamut of colors than before.

The present invention provides a field sequential color display method for obtaining a color image by successively displaying a sequence of images. Each image is displayed with light occupying a different wavelength region, but at least two of the wavelength regions overlap. That is, one of the wavelength regions includes part or all of another one of the wavelength regions.

These two wavelength regions can be used to display one of the original primary colors of the color image, the included or partially included wavelength region being used for comparatively low gray levels and both wavelength regions being used for comparatively high gray levels. This scheme provides a way to increase the number of gray levels that can be displayed following a gray scale conversion, as well as broadening the gamut of reproducible colors.

### BRIEF DESCRIPTION OF THE DRAWINGS

In the attached drawings:

FIG. 1 is a block diagram of a field sequential color display apparatus according to an embodiment of the invention;

FIG. 2 is a plan view of the color selector in FIG. 1;

FIG. 3 indicates the wavelength regions of light selected by the color selector;

FIG. 4 indicates the wavelength region of the light output by the light source;

FIG. 5 indicates the wavelength region of blue light selected by the color selector;

FIG. 6 indicates the wavelength region of green light selected by the color selector;

FIG. 7 indicates the wavelength region of the first red light selected by the color selector;

FIG. 8 indicates the wavelength region of the second red light selected by the color selector;

FIG. 9 indicates the sequence in which the colors of light are selected by the color selector;

FIG. 10 shows examples of the allocation of gray levels to the first red light and second red light;

FIG. 11 is a graph showing the relation of displayed luminance L to the input image data Va and the gray scale data W supplied to the light valve in conventional apparatus;

FIGS. 12 and 13 are graphs illustrating conventional gray scale conversion;

FIG. 14 is a graph showing an exemplary relation of displayed luminance to gray scale data values in the embodiment of the invention;

FIGS. 15A, 15B, 16A, and 16B are graphs showing other possible examples of the relations among displayed luminance L, the input image data Va and the gray scale data W supplied to the light valve in the embodiment of the invention, and illustrate and the corresponding gray scale conversion characteristic of the gray scale controller;

FIG. 17 is a graph showing further exemplary relations of displayed luminance L to the gray scale data W supplied to the light valve in the embodiment of the invention;

FIG. 18 shows an alternative configuration of the color selector in the embodiment;

FIG. 19 is a graph showing the transmittance characteristic of the first blue filter in the color selector in FIG. 18;

FIG. 20 is a graph showing the transmittance characteristic of the second blue filter in the color selector in FIG. 18;

FIG. 21 is a graph showing the transmittance characteristic of the first green filter in the color selector in FIG. 18; and

FIG. 22 is a graph showing the transmittance characteristic of the second green filter in the color selector in FIG. 18.

### DETAILED DESCRIPTION OF THE INVENTION

An embodiment of the invention will now be described with reference to the attached drawings, in which like elements are indicated by like reference characters.

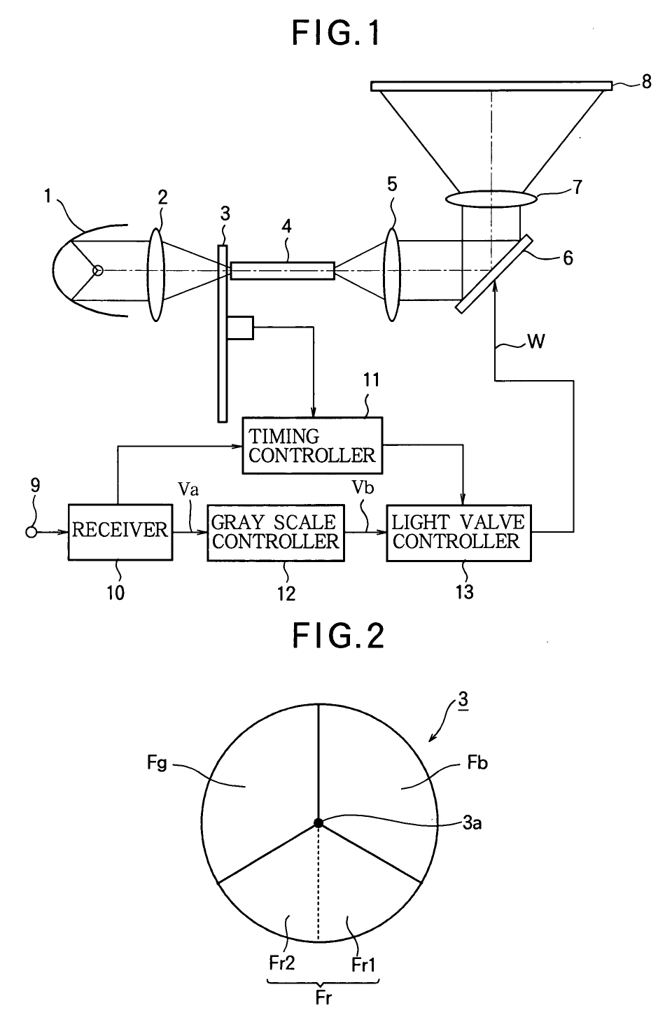

A field sequential color display apparatus embodying the invention is shown in FIG. 1. An image signal input from an input terminal 9 is received by a receiver 10 that outputs image data Va and a timing signal indicating the start of each frame. The timing signal is passed to a timing controller 11. The image data Va are passed to a gray scale controller 12 that performs a gray scale conversion and outputs converted image data Vb.

The timing controller 11 receives timing information on color selection from a color selector 3 and the timing signal output from the receiver 10, and outputs a timing signal for operating a light valve controller 13. The light valve controller 13 generates gray scale data W for the color image from the converted image data Vb according to the timing signal output from the timing controller 11, and outputs the generated gray scale data W to a light valve 6.

Each of the image data Va output from the receiver 10, the image data Vb output from the gray scale controller 12, and the gray scale data W output from the light valve controller 13 consist of, for example, red color data, green color data, and blue color data for displaying the color image.

A light source 1 outputs white light that enters the color selector 3 via a condenser lens 2. The color selector 3 successively selects light with red, green, and blue wavelengths. More specifically, as the light valve controller 13 successively outputs red, green, and blue color data, the color selector 3 successively selects, red, green, and blue light in synchronization with the output of the color data so that the selected color matches the color represented by the data.

The light with a series of different wavelengths that is selected in the color selector 3 enters the light valve 6 via a light pipe 4 and an illumination lens 5.

The light valve 6 outputs image light for each picture element (pixel) of the image by on-off pulse width modulation of the light selected by the color selector 3. The gray scale data W supplied from the light valve controller 13 to the light valve 6 determine the on-duration of the image light. When light of each color is selected in each frame, each pixel element in the light valve 6 is turned on for a time duration (pulse width) proportional to the gray scale value expressed by the gray scale data W for the corresponding pixel and the selected color. If the light valve 6 is a reflective device such as a digital micromirror device (DMD), a pulse of light with a width proportional to the gray scale value is reflected off the light valve 6.

The image light generated in the light valve 6 passes through a projection lens 7 and is displayed as an image on the screen 8. The light valve 6 displays a sequence of monochromatic images with light of the wavelengths selected by the color selector 3 on the screen; these images are perceived as a color image.

The color selector 3 comprises a color filter wheel of the type shown in FIG. 2. The color filter wheel is a disc rotatable around an axis 3a, and includes different color filters disposed in different sectors: a green color filter Fg, a blue color filter Fb, and a red color filter Fr. The red color filter Fr includes a first red color filter Fr1 and a second red color filter Fr2. As the color filter wheel turns, light in the wavelength regions transmitted by the color filters is successively selected from the white light output from the light source 1.

In the exemplary color filter wheel in FIG. 2, the area of the sector occupied by green color filter Fg, the area of the sector occupied by blue color filter Fb, and the area of the sector occupied by red color filter Fr are equal, each being one-third of the whole area of the color filter wheel. The areas of the sectors occupied by the first and second red color filters Fr1 and Fr2 are also equal, each being one-sixth of the whole area of the color filter wheel. In general, however, the areas occupied by the red, blue, and green color filters Fr, Fb, and Fg may differ, and the two red color filters Fr1 and Fr2 may also differ in area.

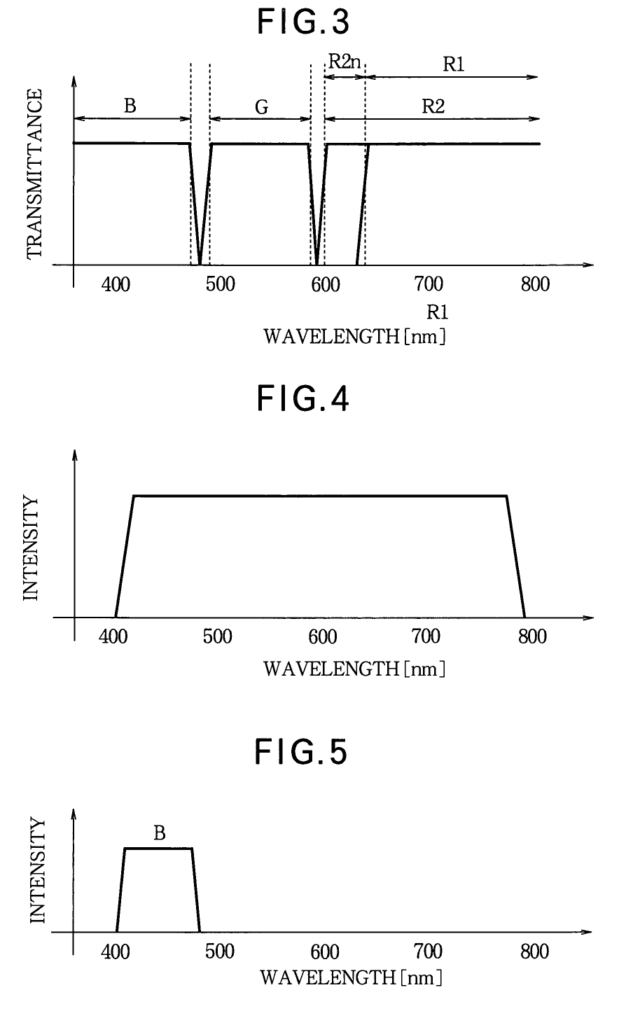

The spectral transmittance characteristics of the color filters in the color selector 3 in FIG. 2 are illustrated in FIG. 3. The wavelength region R1 of light that passes through the first red filter Fr1 and the wavelength region R2 of light that passes through the second red filter Fr2 accordingly overlap: the second wavelength region R2 includes part or all of the first wavelength region R1, and also includes a wavelength region R2n distinct from but contiguous with the included part of the first wavelength region. In this example the first wavelength region R1 is entirely included in the second wavelength region R2, and the contiguous region R2n is contiguous on the short wavelength end of the first wavelength region R1.

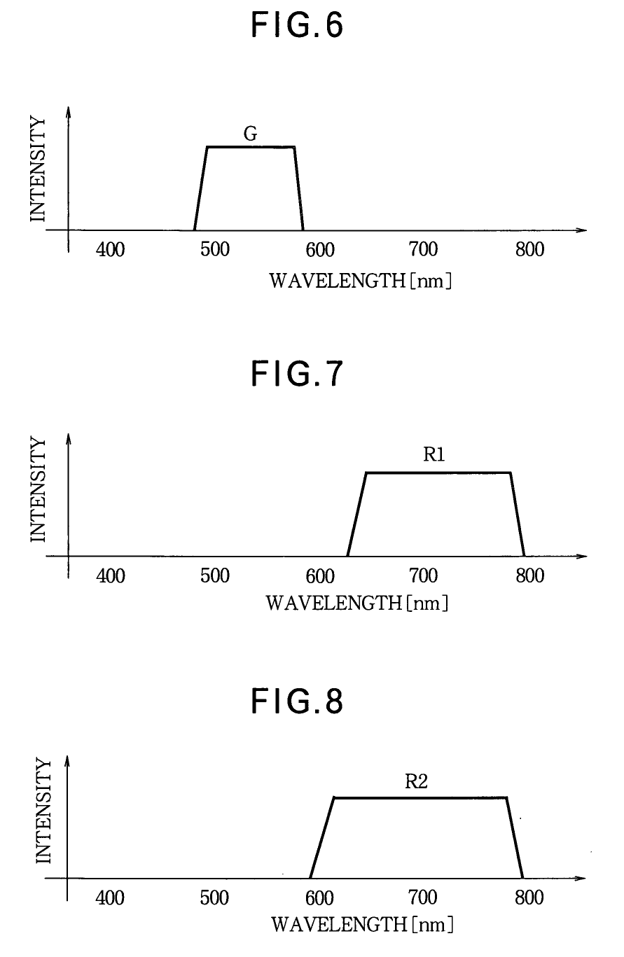

The spectrum of the white light output from the light source 1 includes the entire visible light spectrum as shown in FIG. 4. The spectra (wavelength regions) of the blue light B selected by the blue filter Fb, the green light G selected by the green filter Fg, the first red light R1 selected by the first red filter Fr1, and the second red light R2 selected by the second red filter Fr2 are shown in FIGS. 5, 6, 7, and 8, respectively.

Referring to FIGS. 7 and 8, because the red light R1 selected by the first red filter Fr1 has comparatively high color purity, when the first red light R1 is selected by the first red filter Fr1, a comparatively vivid red image is displayed. Because the red light R2 selected by the second red filter Fr2 includes a wider wavelength region, it includes more light, so when the second red light R2 is selected by the second red filter Fr2, a brighter red image is displayed. In the embodiment, when the red field is displayed, if the gray level is comparatively low, more specifically, if the gray level indicated by the red color data is equal to or less than a predetermined level, the light valve 6 reflects light when the first red filter Fr1 is selected but not when the second red filter Fr2 is selected, thereby displaying a red color of high purity; if the gray level is comparatively high, more specifically, if the gray level indicated by the red color data exceeds the predetermined level, the light valve 6 reflects light when both the first and second red filters Fr1 and Fr2 are selected, thereby displaying a bright red color.

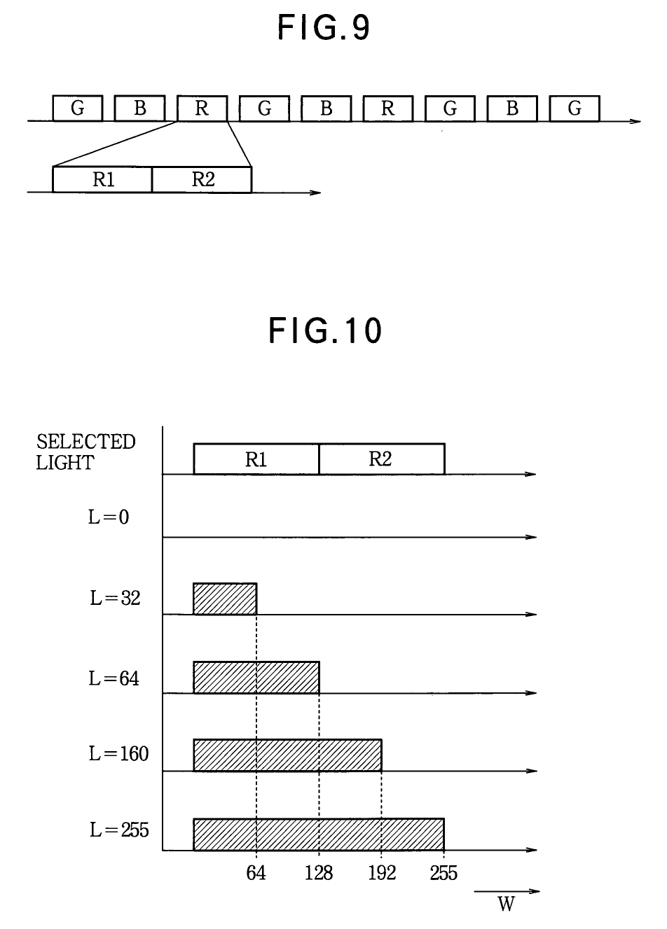

The color selector 3 selects the colors in the sequence shown in FIG. 9, where the horizontal axis indicates time. By rotating, the color selector 3 successively selects green light G, blue light B, first red light R1, and second red light R2 with the wavelength regions shown in FIGS. 5 to 8 from the white light output from the light source 1. The red, green, and blue fields are temporally separated as shown in FIG. 9 to prevent mixing of colors; that is, the light output when the light pipe 4 is aligned with the boundaries between the red, green, and blue filters is not used. In the red field, however, the monochromatic images displayed with the first red light R1 and second red light R2 are not separated; a single continuous red image is displayed.

An example of how this works for eight-bit image data is shown in FIG. 10. The brightness level or luminance L of a pixel in the red field is proportional to the average brightness of the modulated light of the pixel over the duration of the field. In the example in FIG. 10, the ratio of the brightness of the first red light R1 to the brightness of the second red light R2 is assumed to be 1:3. The horizontal axis indicates the gray scale data W received by the light valve 6. The reflection time (on-duration) of each pixel in the light valve 6 is proportional to the gray scale data W. The luminance (L) of a pixel is proportional to the R1 reflection time plus three times the R2 reflection time. The luminance values in FIG. 10 are scaled so that 255 represents the maximum luminance level (in the following discussion, the approximation 255=256 is implicitly used).

When the value of the gray scale data W received by the light valve 6 is zero, the light valve 6 reflects neither first red light R1 nor second red light R2, so the luminance value L is zero (in the red field, the pixel is black).

When the value of the gray scale data W is 64, the light valve 6 reflects light during half of the interval in which the first red light R1 is selected by the color selector 3, and the luminance value L is 32.

When the value of the gray scale data W is 128, the light valve 6 reflects throughout the interval in which first red light R1 is selected, and the luminance value L is 64.

When the value of the gray scale data W exceeds 128, the light valve 6 reflects throughout the interval in which the first red light R1 is selected and in part or all of the interval in which the second red light R2 is selected, and the luminance value L exceeds 64. For example, if the value of the gray scale data W is 192, the light valve 6 reflects all of the selected first red light R1 and half of the selected second red light R2, and the luminance value L is 160.

When the value of the gray scale data W is 255, the light valve 6 reflects all the first red light R1 and second red light R2, and the luminance value L is 255.

As described above, red pixels with comparatively low gray levels (comparatively dark red pixels) are displayed with red light R1 of high color purity, and red pixels with higher gray levels are displayed with a combination of the high-purity first red light R1 and the brighter second red light R2. Accordingly, at comparatively low gray levels, the color selector 3 and light valve 6 can display a color image with deep reds of high color purity, and at comparatively high gray levels, the color selector 3 and light valve 6 can display an image with enhanced red brightness. The gamut of reproducible colors is thereby extended.

A fundamental problem of color displays is that they operate by emitting light while most subjects in nature are seen by reflected light. A subject that reflects only a narrow range of deep red wavelengths produces a color with a red component that, although not bright, is pure and vivid. This color cannot be reproduced by a conventional display unless it uses a red light source that targets only the far end of the red spectrum, but then the display will be unable to produce bright red colors requiring a broader range of red wavelengths. The present embodiment can display both deep red colors and bright red colors.

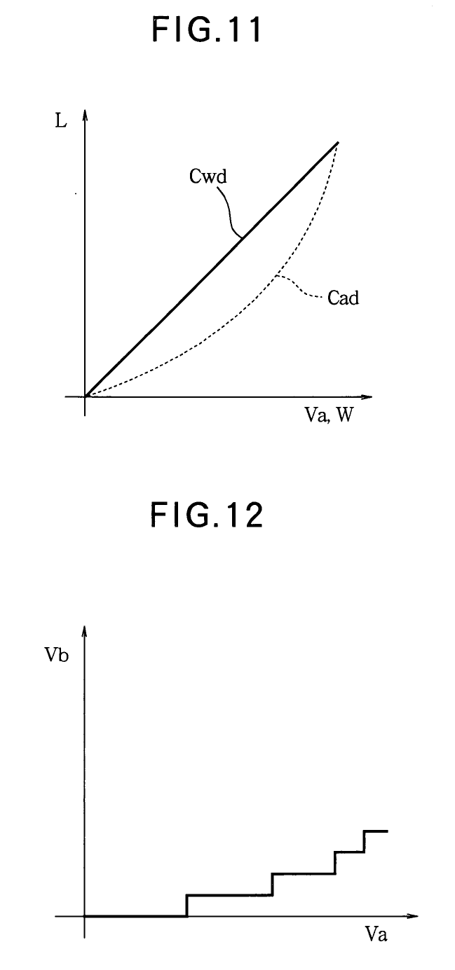

The gray scale conversion characteristic used in conventional display apparatus is illustrated in FIG. 11. The straight line Cwd indicates the operating characteristic of the light valve 6, indicating the relation of pixel luminance L in the displayed image to the gray scale data W supplied to the light valve 6. The dotted curve Cad schematically indicates the desired input-output characteristic (a so-called gamma curve) of the display apparatus, relating pixel luminance L to the input image data Va. Since pixel luminance L varies linearly with the gray scale data W, the gray scale of the input data Va must be converted (the data values must be altered) so that the modulated light will produce the proper luminance L.

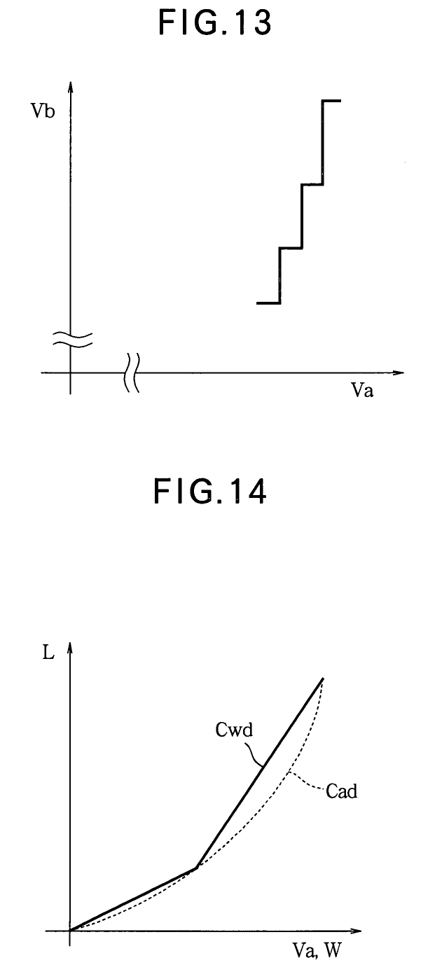

Enlarged parts of the gray scale conversion curve used when the luminance L varies linearly with the gray scale data W are shown in FIGS. 12 and 13: FIG. 12 shows the low end of the gray scale; FIG. 13 shows the high end. The converted image data Vb are linearly related to the gray scale data W output from the light valve controller 13.

As shown in FIG. 12, at the lower end of the gray scale, the input image data Va can change by several gray levels without causing a change in the converted image data Vb. As shown in FIG. 13, at the high end of the gray scale, the converted image data Vb change more than the image data Va and accordingly skip some gray levels. For these reasons, if image data Va and Vb are both eight-bit data, then although the input image data Va can express 256 gray levels, the converted image data Vb express fewer than 256 gray levels.

FIG. 14 shows the relation of red pixel luminance L in the displayed image to the gray scale data W when the light valve 6 modulates the first red light R1 and second red light R2 as indicated in FIG. 10. As in FIG. 11, the dotted curve Cad represents the desired input-output characteristic (Va to L), and the line marked Cwd represents the operating characteristic of the light valve 6 (W to L) . At lower gray levels, when only the first red light R1 selected by the color selector 3 is used for pixel display, the slope of line Cwd is comparatively modest; at higher gray levels in which both the first red light R1 and second red light R2 are used, the slope of line Cwd is comparatively steep. The pixel luminance L therefore does not have a straight linear relation to the gray scale data W received by the light valve 6; the line Cwd is bent so that it more closely approaches the desired input-output curve Cad.

The result is that the W-L relation is already close to the desired Va-L relation, and the gray scale controller 12 does not have to change the input image data Va by very much to obtain the desired pixel luminance levels. Consequently, fewer gray levels are lost in the data conversion process, and the number of gray levels that can be displayed increases.

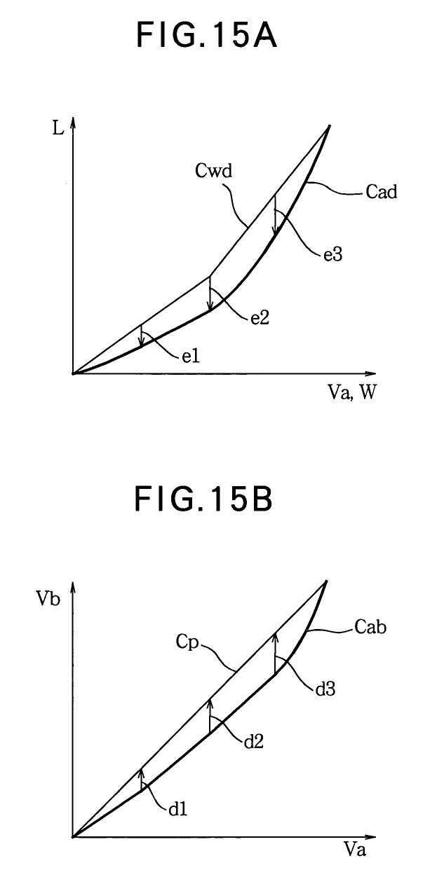

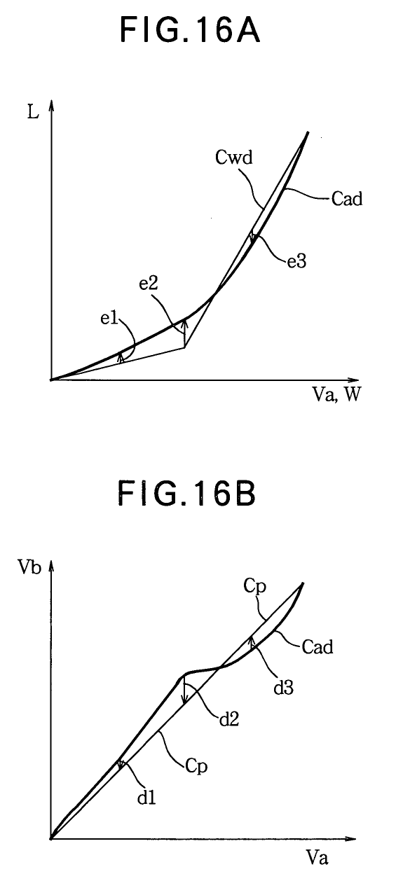

The shape of the bent line Cwd, which is determined by the characteristics of the red filters Fr1 and Fr2, determines the shape of the conversion curve used in the gray scale controller 12. Placing the bend in line Cwd on the desired gray scale characteristic Cad as in FIG. 14 results in a relatively small loss of gray levels, but other placements are possible. Two examples and the resulting conversion curves are shown in FIGS. 15A, 15B, 16A, and 16B.

In FIGS. 15A and 16A, as in FIG. 11, curve Cad indicates the desired relation of pixel luminance L to the input image data Va and line Cwd indicates the relation of pixel luminance L to the gray scale data W supplied to the light valve 6. The arrows e1, e2, e3 indicate the conversion left to be performed by the gray scale controller 12.

FIGS. 15B and 16B indicate relations between input image data Va and converted image data Vb. Line Cp indicates the equality relation (Vb=Va). Curve Cab indicates how the gray scale controller 12 converts the input image data Va to the converted image data Vb. Arrows d1, d2, and d3 in FIGS. 15b and 16b are identical to the arrows e1, e2, and e3 in FIGS. 15a and 16a, respectively, with the direction reversed.

When the bend in the Cwd line is placed above the Cad curve as in FIG. 15A, it will be appreciated from FIG. 15B that there is still some loss of gray levels at the low end of the gray scale, although not as much as in FIGS. 11 and 12. When the bend in the Cwd line is placed as far below the Cad curve as in FIG. 16A, there is no loss of gray levels at the low end of the gray scale, where the gray scale is slightly expanded instead of being compressed, but some gray levels are lost in the middle of the gray scale, as can be seen from FIG. 16B.

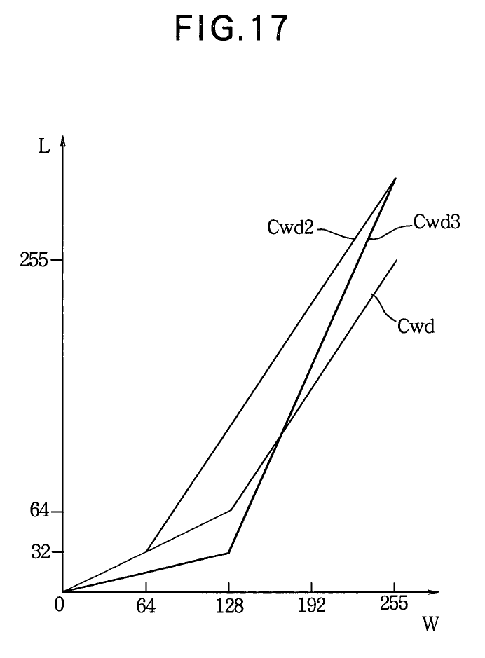

The different shapes of line Cwd in FIGS. 14, 15A, and 15B can be obtained by using a color filter wheel of the type shown in FIG. 2, in which the first and second red color filters Fr1 and Fr2 have equal areas, by changing the transmittance characteristics of these filters. Another type of adjustment can be made by changing the relative areas of the first and second red color filters Fr1 and Fr2. FIG. 17 shows examples of both types of adjustments.

Line Cwd in FIG. 17 is identical to line Cwd in FIG. 14 (although with different scales on the vertical and horizontal axes), showing the relation of pixel luminance L to the gray scale data W when the first and second red color filters Fr1 and Fr2 are occupy equal areas, so that half of the gray scale is displayed by the first red light R1 alone, and the other half is displayed by a combination of first red light R1 and second red light R2.

Line Cwd2 in FIG. 17 shows the relation of pixel luminance L to the gray scale data W when the area of the first red color filter Fr1 is one-third of the area of the second red color filter Fr2. Now the lower one-fourth of the gray scale is displayed by use of the first red light R1 alone, the remaining three-fourths being displayed by a combination of the first red light R1 and the second red light R2. The slope of line Cwd2 changes at the point where the gray scale value of the data W is 64 (one-fourth of the maximum gray scale value). The maximum displayable red luminance level is increased, resulting in a wider gamut of reproducible colors.

Line Cwd3 in FIG. 17 shows the relation of pixel luminance L to the gray scale data W supplied to the light valve 6 when the first and second red color filters Fr1 and Fr2 have equal areas, but the transmittance of the first red color filter Fr1 is reduced and the transmittance of the second red color filter Fr2 is increased, as compared with the case illustrated in FIG. 14. At the low end of the gray scale, loss of gray levels is eliminated as in FIG. 16a and 16b; at the high end of the gray scale, the maximum displayable red luminance level is increased, resulting in a wider gamut of reproducible colors, as with line Cw2.

As these examples show, by using the first red light R1 to display red pixels with comparatively low gray levels and using both the first red light R1 and the second red light R2 to display red pixels with higher gray levels, it is possible to reduce the loss of gray levels caused by gray scale conversion, and also to broaden the gamut of reproducible colors.

It is not necessary for the color selector 3 to select light of just three primary colors, or for only the red light to include first light and second light spanning different wavelength regions. The color selector 3 may select more than three colors: for example, yellow (Y) and cyan (C) may be added to the three primary colors red, green, and blue. Colors other than red may also by displayed by using first light of high color purity and second light of high brightness. The color selector 3 may be configured in various ways.

In these variations, as above, when the color selector 3 selects light of each color, the gray scale data W supplied from the light valve controller 13 to the light valve 6 determine the on-duration of the selected light. To include these alternative configurations of the color selector 3, the color display of the present invention may be generalized as follows. The color selector 3 successively selects light with N different wavelength regions from the light source 1, where N is a positive integer, the N different wavelength regions being consecutively numbered to include a first wavelength region and an Nth wavelength region. The gray scale controller 12 converts the gray scale of the input color image data for M colors to generate converted image data for N colors from a first color to an Nth color, where M is a positive integer less than N. The light valve 6 modulates the light with the wavelength region selected by the color selector 3 according to the converted image data output by the gray scale controller 12 for each pixel in the color image, thereby obtaining image light of the N colors. Among the N wavelength regions, a Jth wavelength and a Kth wavelength region mutually overlap, where J and K are two different integers equal to or greater than one and equal to or less than N. The light valve 6 modulates both the light output when the color selector 3 selects the Jth wavelength region and the light output when the color selector 3 selects the Kth wavelength region according to the color image data for an Lth color, where L is an integer equal to or greater than one and equal to or less than M.

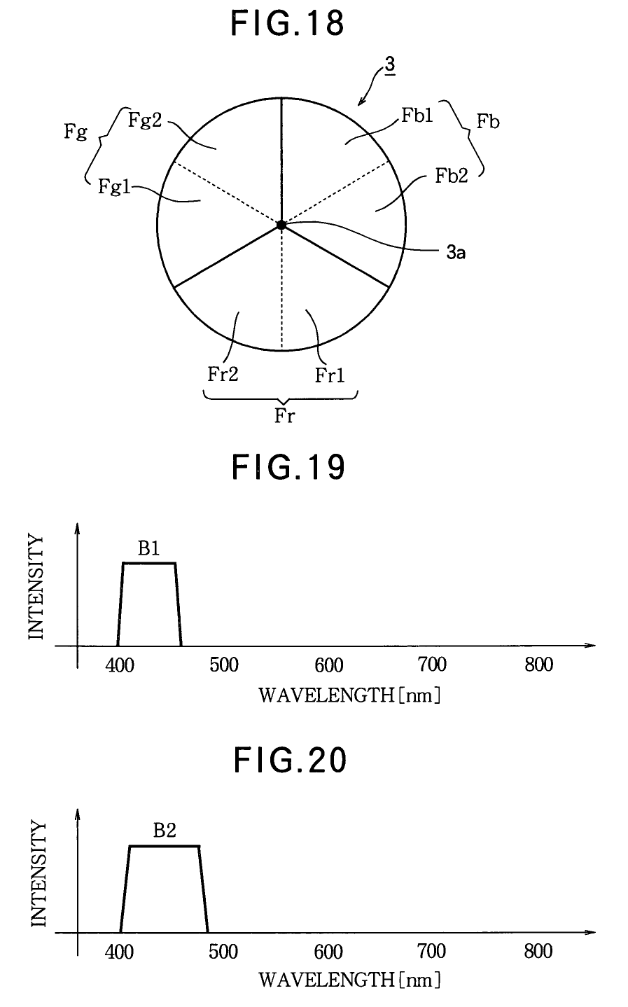

One example of a color selector 3 comprising a color filter wheel with an alternative configuration is shown in FIG. 18. The color filter wheel includes a red color filter Fr, a green color filter Fg, and a blue color filter Fb; the red color filter Fr includes a first red color filter Fr1 and a second red color filter Fr2, the green color filter Fg includes a first green color filter Fg1 and a second green color filter Fg2, and the blue color filter Fb includes a first blue color filter Fb1 and a second blue color filter Fb2.

In the exemplary color filter wheel in FIG. 18, the red color filter Fr, green color filter Fg, and blue color filter Fb occupy equal areas, each being one-third of the whole area of the color filter wheel. The first and second red color filters Fr1 and Fr2, first and second green color filters Fg1 and Fg2, and first and second blue color filters Fb1 and Fb2 also occupy equal areas, each being one-sixth of the whole area of the color filter wheel. In general, however, the areas occupied by the red, blue, and green color filters Fr, Fb, and Fg may differ, the areas of the two red color filters Fr1 and Fr2 may differ, the areas of the two green color filters Fg1 and Fg2 may differ, and the areas of the two blue color filters Fb1 and Fb2 may differ.

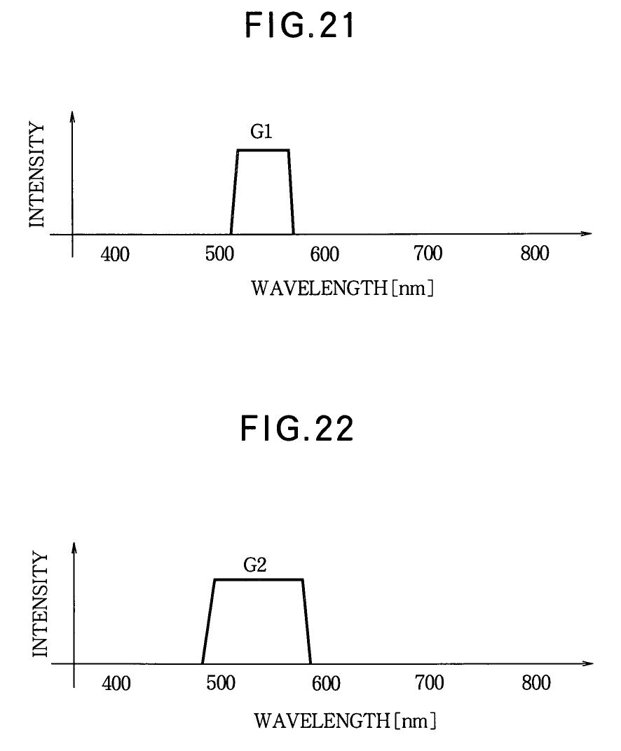

Exemplary spectra (wavelength regions) of the first blue light B1 selected by the first blue filter Fb1 of the color selector 3, the second blue light B2 selected by the second blue filter Fb2, the first green light G1 selected by the first green filter Fg1, and the second green light G2 selected by the second green filter Fg2 are shown in FIGS. 19, 20, 21, and 22, respectively. For the color green, the G1 spectrum is entirely included within the G2 spectrum, which is wider than the G1 spectrum at both the upper and lower ends.

In this example, the green and blue color image data are displayed in the same way as the red image data described above. That is, the lower half of the gray scale in the green image is displayed with the first green light G1, and the upper half is displayed with both the first green light G1 and the second green light G2. Similarly, the lower half of the gray scale in the blue image is displayed with the first blue light B1, and the upper half is displayed with both the first blue light B1 and the second blue light B2. As with red, however, the relation of pixel luminance L to the gray scale data W supplied to the light valve 6 can be adjusted by varying the widths of the first and second green and blue color filters Fg1, Fg2, Fb1, Fb2 so that different fractions of the gray scale are allocated to the first and second green and blue light.

The filter of a single color may be divided into three or more parts, to provide three or more types of light spanning different wavelength regions. For example, a series of gradually broadening wavelength regions may be provided. The line representing the luminance-to-data relation then bends at more than one point, and can be more closely tailored to match the desired input-output characteristic, further reducing the need for gray scale conversion and increasing the number of different gray levels that can be displayed.

The different monochromatic images representing different wavelength regions of the same color do not have to be displayed consecutively as shown in FIGS. 9 and 10. A sequence such as R1-G-R2-B may be used for example, the light valve 6 being controlled to modulate the first and second red light separately. If the first red light is used for comparatively low gray levels and both the first red light and second red light are used for higher gray levels, the perceived result will be the same as in the embodiment described above.

Selecting all light representing the same primary color consecutively as in the embodiment above has the advantage, however, of providing a brighter image, because it is also possible to use light transmitted partly through one filter and partly through another filter when the two filters represent the same primary color. In FIG. 9, for example, the red field R does not have to be divided into two temporally separated regions.

The light valve need not operate by controlling light reflection time according to the value of the gray scale data W as in the embodiment described above. Any optical modulation method may be used. For example, the light valve may operate by controlling light reflectance, light transmittance, or light transmitting time.

The invention is not limited to use in a projector that projects a color image on a screen. The invention is also useful in, for example, a direct-view liquid crystal display light valve.

Those skilled in the art will recognize that further variations are possible within the scope of the invention, which is defined in the appended claims.

What is claimed is:

1. A field sequential color display method for obtaining a color image by successively displaying a sequence of images in different colors, wherein;
the light of at least one of the colors is a combination of first light with wavelengths forming a first wavelength region and second light with wavelengths forming a second wavelength region differing from the first wavelength region; and
the second wavelength region includes at least part of the first wavelength region and also includes a wavelength region distinct from but contiguous with the included part of the first wavelength region.

2. The field sequential color display method of claim 1, wherein the first wavelength region is narrower than the second wavelength region.

3. The field sequential color display method of claim 2, wherein the first wavelength region is entirely included in the second wavelength region.

4. The field sequential color display method of claim 2, wherein said one of the colors has a gray scale including a comparatively low part displayed by the first light and a comparatively high part displayed by both the first light and the second light.

5. The field sequential color display method of claim 1, comprising:
modulating the first light to generate first output image light;
modulating the second light to generate second output image light; and
converting a gray scale of said one of the colors so that the first output image light and the second output image light, taken in combination, have a desired gray scale characteristic.

6. The field sequential color display method of claim 1, wherein the images displayed using the first light and the second light are displayed consecutively in the sequence of images.

7. A field sequential color image display apparatus for displaying a color image by successively displaying a sequence of images in different colors according to input color image data, comprising:
a gray scale converter for converting a gray scale of the input color image data to generate converted image data;
a light source for output of light for displaying the color image;
a color selector for successively selecting light of a series of different wavelength regions from the light output by the light source; and
a light valve for modulating the light of the wavelength region selected by the color selector according to the converted image data output by the gray scale converter for each picture element in the color image, thereby obtaining the displayed color image; wherein
at least two of the wavelength regions selected by the color selector mutually overlap; and
the light of the two mutually overlapping wavelength regions is combined to display one of the colors.

8. The field sequential color image display apparatus of claim 7, wherein one of the two mutually overlapping wavelength regions is narrower than another one of the two mutually overlapping wavelength regions.

9. The field sequential color image display apparatus of claim 8, wherein said one of the two mutually overlapping wavelength regions is entirely included within said another one of the two mutually overlapping wavelength regions.

10. The field sequential color image display apparatus of claim 8, wherein the gray scale of said one of the colors includes a comparatively low part displayed by the light of said one of the two mutually overlapping wavelength regions and a comparatively high part displayed by both the light of said one of the two mutually overlapping wavelength regions and the light of said another one of the two mutually overlapping wavelength regions.

11. The field sequential color image display apparatus of claim 7, wherein the light valve modulates the light of said one of the two mutually overlapping wavelength regions to generate first output image light and modulates the light of said another one of the two mutually overlapping wavelength regions to generate second output image light, and the gray scale converter converts the gray scale of the input color image data of so that the first output image light and the second output image light, taken in combination, have a desired gray scale characteristic.

12. The field sequential color image display apparatus of claim 7, wherein the images displayed using the light of the first wavelength region and the light of the second wavelength region are displayed consecutively in the sequence of images.

13. A field sequential color image display apparatus for displaying a color image by successively displaying a sequence of images in different colors according to input color image data for M colors, where M is a positive integer, comprising:
a light source for output of light for displaying the color image;
a color selector for successively selecting light of N different wavelength regi6ns from the light output by the light source, where N is a positive integer greater than M, the N different wavelength regions being consecutively numbered to include a first wavelength region and an Nth wavelength region;
a gray scale converter for converting a gray scale of the input color image data for the M colors to generate converted image data of N colors from a first color to an Nth color; and
a light valve for modulating the light of the wavelength region selected by the color selector according to the converted image data output by the gray scale converter for each picture element in the color image, thereby obtaining image light of the N colors; wherein
among the N wavelength regions, a Jth wavelength and a Kth wavelength region mutually overlap, where J and K are two different integers equal to or greater than one and equal to or less than N; and
the light valve modulates both the light output when the light selector selects the Jth wavelength region and the light output when the light selector selects the Kth wavelength region according to the color image data for an Lth color, where L is an integer equal to or greater than one and equal to or less than M.

14. The field sequential color image display apparatus of claim 13, wherein the Jth wavelength region is narrower than the Kth wavelength region.

15. The field sequential color image display apparatus of claim 14, wherein the Jth wavelength region is entirely included in the Kth wavelength region.

16. The field sequential color image display apparatus of claim 14, wherein the light valve outputs the image light by on-off pulse width modulation of the light selected by the light selector for each picture element of the image and wherein:
when the value of the image data for the Lth color for the picture element expresses a gray level equal to or less than a predetermined level, the light valve modulates only light output when the Jth wavelength region is selected to the on-state; and
when the value of the image data for the Lth color for the picture element expresses a gray level greater than the predetermined level, the light valve modulates both light output when the Jth wavelength region is selected and light output when the Kth wavelength region is selected to the on-state.

17. The field sequential color image display apparatus of claim 13, wherein the gray scale converter converts the gray scale of the image data of the Lth color so that the output image light obtained when the light valve modulates the light of the Jth wavelength region and the output image light obtained when the light valve modulates the light of the Kth wavelength region, taken in combination, have a desired gray scale characteristic.

18. The field sequential color image display apparatus of claim 13, wherein the color selector selects the Jth wavelength region and the Kth wavelength region consecutively.
